(19) United States
(12) Patent Application Publication
(10) Pub. No.: US 2021/0239475 A1
(43) Pub. Date: Aug. 5, 2021

(54) Evaluation of a route determination

(71) Applicant: BAYERISCHE MOTOREN WERKE AKTIENGESELLSCHAFT, Munich (DE)

(72) Inventors: Andreas HACKELOEER, Munich (DE); Alexander HARHURIN, Munich (DE)

(21) Appl. No.: 17/164,861

(22) Filed: Feb. 2, 2021

(30) Foreign Application Priority Data
Feb. 4, 2020 (DE) 102020102752.4

(51) Int. Cl. G01C 21/34; G01C 21/36

(52) U.S. Cl. CPC G01C 21/3446; G01C 21/36; G01C 21/3415

(57) ABSTRACT

A method for evaluating a route determination comprises the steps of determining a first route on a first map on the basis of a second route on a second map; determining sections of one of the routes, wherein a particular section is further apart than a first predetermined distance from a corresponding section of the respective other route throughout its course; determining lengths of the sections; and determining a ratio of a sum of the determined lengths to a length of the route.

### CROSS-REFERENCE TO RELATED APPLICATION

This application claims priority to German Application 10 2020 102 752.4, filed on Feb. 4, 2020. The content of this earlier filed application is incorporated by reference herein in its entirety.

### FIELD

The invention relates to the evaluation of a route determination. In particular, the invention relates to determining a quality by which a first route may be determined based on a second route.

### BACKGROUND

A vehicle includes a navigation system configured to assist a driver in guiding the vehicle from a starting point to a destination point. In addition, an interaction system may be provided on board the vehicle, wherein the interaction system may be used by the driver to specify a destination point for route guidance.

The navigation system and the interaction system may work on different geographical maps. For example, the maps may vary in accuracy or up-to-dateness. In addition, deviations of the maps from reality may be different.

To determine a first route defined with respect to a first map on the basis of a second route defined with respect to a second map, a method may be used which may be executed on board the vehicle. If the determination fails, a driver of the vehicle may be provided with information that does not relate to the route actually traveled. The driver may be confused or misguided by this. Therefore, before the method is applied in the vehicle, it shall be ensured that the method reaches a predetermined determination quality.

One object underlying the invention is to evaluate a method for the determination of a first route on a first map with respect to a second route on a second map. The invention solves this object by means of the subject matters of the independent claims. Subclaims represent preferred embodiments.

### SUMMARY

According to a first aspect of the present invention, a method of evaluating a route determination comprises steps of determining a first route on a first map on the basis of a second route on a second map; determining sections of one of the routes, wherein a determined section is further apart than a first predetermined distance from a corresponding section of the respective other route throughout its course; determining lengths of the sections; and determining a ratio of a sum of the determined lengths to a length of the route.

The method allows to prove whether the performed route determination reaches a predetermined quality or not. The method may be carried out with a plurality of second routes, so that the method may be examined with regard to its determination quality.

Preferably, the routes each represent roads having a predetermined minimum width, wherein the first predetermined distance corresponds to at least twice the minimum width. For example, in Europe it may be assumed that a road comprises at least one lane and that a lane is no narrower than approximately 2.5 m. The first predetermined distance may be set to approximately 5 m. If the routes refer to different roads, the routes comprise a distance of at least approximately 5 m to each other, even if the roads are very close to each other. Conversely, routes that comprise a distance of less than approximately 5 m to one another may not refer to different roads. It was found that a movement tolerance of the vehicle between the routes is smaller than the first predetermined distance. The first distance may also be chosen slightly greater to allow for greater deviations between the maps.

In a further preferred embodiment, lengths of the sections are each limited to a second predetermined distance before determining the sum. This may reflect that the determination of the first route, when performed on board a vehicle, may be secured by means of a method that detects a misdetermination.

Determining the first route based on the second route may be configured to be executed on board a vehicle, wherein a misdetermination of the first route may be detected during a travel of the vehicle across the predetermined second distance. The misdetermination may be determined in particular by means of a position estimator operating, for example, on the basis of a determined absolute position and/or a determined relative position of the vehicle. The absolute position may be determined by means of a receiver of a satellite-based navigation system. The relative position may be determined based on a determined movement of the vehicle, for example based on rotational speeds of wheels, camera images of an environment or measurements of an inertial system. A misdetermination may exist if a first estimated position operating on the first map deviates more than predetermined from a second estimated position operating on the second map. In particular, the misdetermination may be determined if the positions deviate from one another by more than the first predetermined distance. Thus, the same criterion for a misdetermination may be used as in the evaluation of the determination method for the first route. Further preferably, the misdetermination may be detected when the determined positions deviate from each other by more than the first predetermined distance across the second predetermined distance. In a common embodiment, the second predetermined distance is approximately 100 m.

In this way, a safety mechanism may be taken into account when evaluating the route determination, which may limit a determination error in the real use of the route determination. In various embodiments, the portion of the section extending going beyond the second distance may be discarded as an error, or a redetermination of the second route may be performed at the location of the second distance in order to continue the evaluation method.

The method may be used to find, in a plurality of second routes, ones on the basis of which the determination of the first route is problematic. In particular, there may be a plurality of second routes; wherein meta-information is associated with the second routes; and wherein the second route is selected based on the meta-information. Example meta-information includes a date, a day of the week, a time, a location, a country, a length of a route, a resolution, or version of an underlying second map.

Preferably, a warning is issued if the determined ratio exceeds a predetermined threshold value. When checking the determination regarding multiple second routes, a warning may be issued if one or a predetermined number of ratios exceeds the threshold value. Determined ratios may also be mapped into a common characteristic number and the warning may be issued if the determined characteristic number exceeds the threshold value.

Several determined ratios may also be output in other ways, for example in the form of a histogram. In a further embodiment, ratios for a plurality of second routes are determined, and further a portion of the ratios that is above a predetermined threshold value is determined.

According to a second aspect of the present invention, a device for evaluating a route determination is configured to perform a method described herein. The device may include a processing device configured to carry out, in whole or in part, a method described herein. For this purpose, the processing device may include a programmable microcomputer or microcontroller and the method may be present in the form of a computer program product with program code means. The computer program product may also be stored on a computer-readable data carrier. Features or advantages of the method may be transferred to the device or vice versa.

The device may be configured to process a plurality of second routes using the same determination method. For this purpose, the device may be realized as a server or service, optionally in a cloud. Several determinations may be executed in parallel to speed up the evaluation. In one embodiment, a massively parallel determination is performed, for which a suitable number of processing devices may be temporarily added to the device.

The device may include a data storage for storing or recording with a plurality of second routes. The second routes may come from real vehicles that have been moved in real life based on the second routes. Metadata relating in particular to circumstances of a vehicle's journey may be stored together with a second route. Preferably, the metadata is organized and/or indexed in such a way so as to allow for a targeted selection of second routes travelled under predetermined boundary conditions. This may allow the targeted identification of circumstances in which the determination of the first route based on the second route is problematic. The determination method may be adapted to better handle these cases and the evaluation of the adapted determination procedure may be executed again.

### BRIEF DESCRIPTION OF THE FIGURES

The invention is now described in more detail with reference to the attached drawings in which:

FIG. 1 illustrates routes defined with respect to different maps;

FIG. 2 illustrates a flow chart of a method; and

FIG. 3 illustrates an exemplary device.

### DETAILED DESCRIPTION

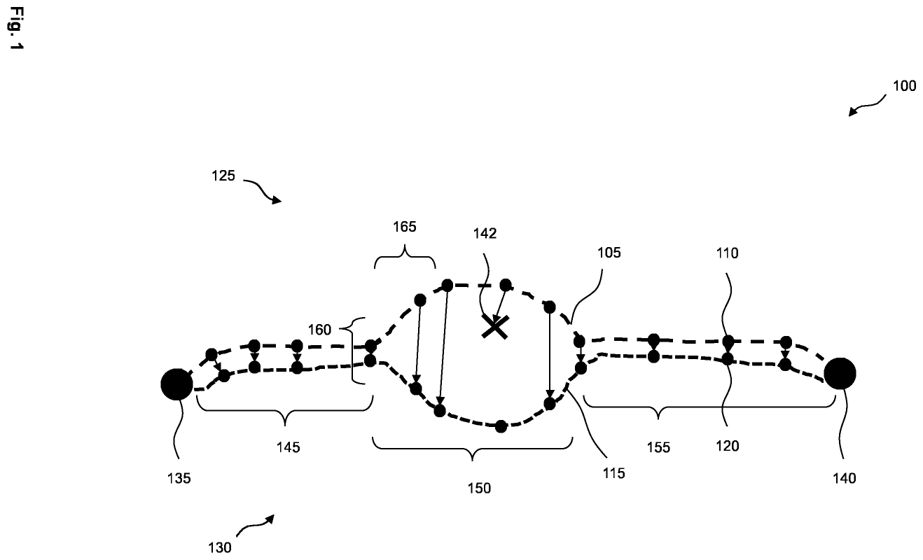

FIG. 1 illustrates exemplary routes defined with respect to different geographical maps. A first route 105 includes points 110 and a second route 115 includes points 120. The points 110, 120 each describe a geographical position. The routes 105, 115 each run along a road. If the routes 105, 115 coincide, they run along the same road.

Here, the first route 105 is defined with respect to a description of the road on a first map 125 and the second route 115 is defined with respect to a description of the road on a second map 130. The descriptions of the two maps 125, 130 typically deviate from one another, for example, because the maps 125, 130 are based on different geodetic systems, or because they are different regarding their up-to-dateness or accuracy. In particular, FIG. 1 graphically depicts the deviations of routes 115, 125 from each other.

Both routes 105, 115 lead from an exemplary starting point 135 to an exemplary destination point 140. A distance between the routes 105 and 115 is determined to be the distance of a first point 110 included in the first route 105 from a second point 120 included in the second route 115 and corresponding to the first point 110. In FIG. 1, arrows are drawn for a pair of corresponding first and second points 110, 120, the lengths of which represent a respective distance. One of the arrows leads to a position 142, which is not on any road and may also be called “off-road position”. Such a position may be identified as an obvious error.

Typically, second points 120 are placed on the second route 115 at locations where the second route 115 may become ambiguous because multiple paths are possible to the destination point 140 via a road network noted on the second map 130. Such locations include, for example, an intersection, a roundabout, or a fork in a road. First points 110 corresponding to the second points 120 may be determined using a search method on the first map 125. Determined first points 110 may be assigned state probabilities, and transitions between determined first points 110 may be assigned transition probabilities. The first route 105 may be determined to maximize a product of determined probabilities of included first points 110 or transitions.

It is particularly preferred that the first route 105 is determined using Trace Matching based on the second route 115. In particular, a Hidden Markov Model may be used for this purpose, where second points 120 of the second route 115 represent observed states and first points 110 of the first route 105 represent hidden states for the Markov Model.

In the representation of FIG. 1, the routes 105, 115 run close to each other in a first section 145, are further apart in a second section 150, and are close to each other again in a subsequent third section 155. A distance of the routes 105, 115 from each other is determined by distances of included first and second points 110, 120 from each other. On the sections 145 and 155, the routes 105, 115 are less than a first predetermined distance 160 apart from each other because the corresponding points 110, 120 included in the sections 145, 155 are less than the first predetermined distance 160 apart from each other. However, on the middle section 150, the routes 105 and 115 are further apart than the first predetermined distance 160.

If the first route 105 is determined based on the second route 115 aboard a vehicle traveling from the starting point 135 to the destination point 140, a position of the vehicle may be continuously determined. The determination may be made with respect to the first map 125 and with respect to the second map 130. For example, if the two positions determined this way deviate from each other by more than the first predetermined distance 160, a misdetermination of the first route 105 may be determined. In particular, the misdetermination may be determined if the determined positions deviate from each other along the travel across a predetermined second distance 165 by more than what was predetermined.

If a misdetermination has been detected on board the vehicle, the determination of the first route 105 may be restarted based on the second route 115. Other measures to resolve the conflict are also possible.

In order to evaluate a method for determining the first route 105 based on the second route 115, it is proposed to determine sections 150 on which the routes 105 and 115 exceed a first predetermined distance 160 from each other. In one embodiment, the determined lengths may be limited to the second predetermined distance upward. Determined lengths of the sections 150 may be summed and then divided by the length of one of the two routes 105, 115. The resulting ratio may represent an error value for the quality of the determination method of the first route 105. The smaller the error value, the more successful the determination of the first route 105 based on the second route 115 may be.

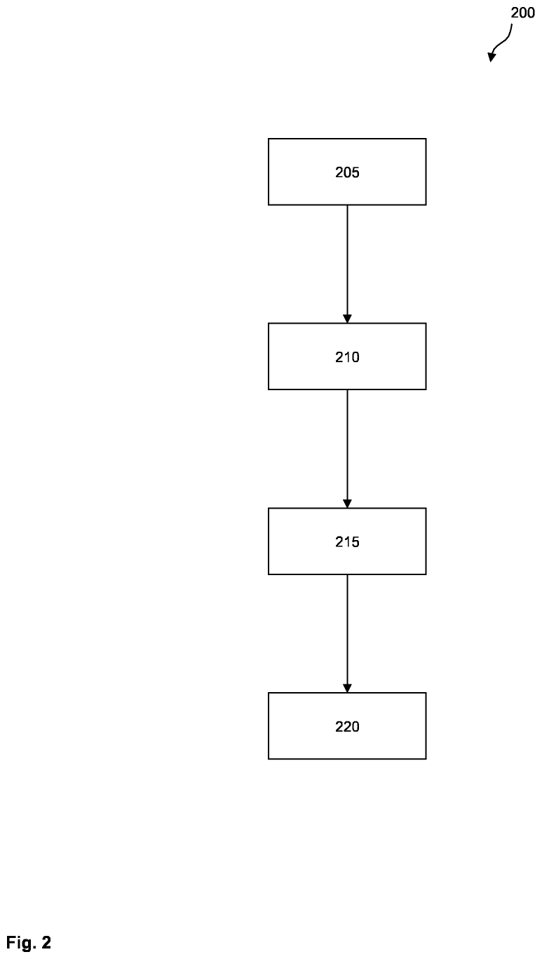

FIG. 2 shows a flowchart of a method 200 to evaluate a determination method to determine a first route 105 on a first map 125 on the basis of a second route 115 on a second map 130.

In a step 205 a second route 115 may be determined. For this purpose, a plurality of second routes 115 may be available for selection. The second routes 115 may have been determined based on real trips made by vehicles along the second routes 115. Circumstances of the trips may be stored in metadata. One or more second routes 115 may be selected based on the metadata. For example, routes 115 may be selected that are no longer than a predetermined distance and have been traveled within a predetermined time range.

In a step 210, a first route 105 may be determined for a particular second route 115. In particular, the determination may be performed using a Trace Matcher, preferably based on a Hidden Markov Model. By means of the determination method performed in this step, the second route 115 on the second map 130 may be transcribed to the first route 105 on the first map 130.

In a step 215, sections 150 may be determined on which the routes 105, 115 deviate by more than the first predetermined distance 160 from one another. Distances between mutually corresponding points 110, 120 in the determined section 150 should be consistently greater than the first predetermined distance 160. The section 150 is completed when the distance between mutually corresponding points 110, 120 is less than the first predetermined distance 160.

In a step 220, the performed determination of the first route 105 may be evaluated. In this respect, the lengths of the sections 150 may be considered on which the routes 105, 115 deviate from each other by more than the first predetermined measure 160. In one embodiment, these lengths may be summed. In another embodiment, the determined lengths may be limited to a maximum distance before summing, in particular to the second predetermined distance 165. The determined sum may then be divided by the length of the first route 105 or the second route 115. The resulting ratio may be interpreted as an error value, which is the smaller the better the success of the determination of the first route 105 based on the second route 115.

A number of ratios equal to a plurality of second routes 115 may be determined. The determined ratios may be further related to, for example, the length of the respective second route 115 under consideration. The resulting ratios may be visualized in the manner of a histogram. Other representations of the specific ratios are also possible.

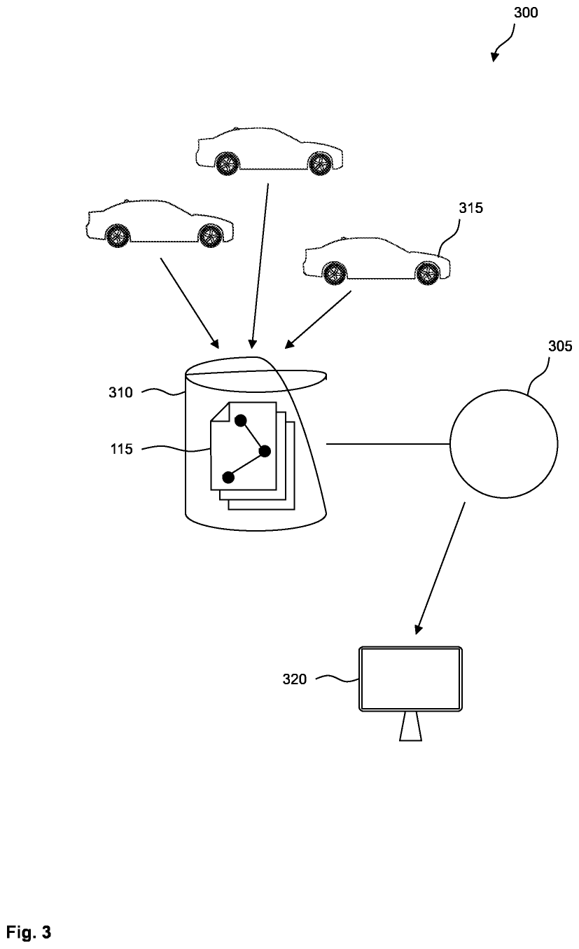

FIG. 3 illustrates an exemplary device 300 for evaluating a method for determining a first route 105 based on a second route 115. The device 300 includes a processing device 305 configured to perform a method described herein, and preferably a data storage 310 for storing or recording second routes 115 each defined with respect to a second map 130. In particular, the second routes 115 may be determined by observation at a vehicle 315. Alternatively, a second route 115 may also be determined using, for example, a service or a method to be used on board a vehicle 315 when the first route 105 is to be determined based on the second route 115.

A plurality of processing devices 305 may be provided to determine, in parallel, a plurality of first routes 105 each based on a predetermined second route 115. To this end, for example, processing devices 305 may be dynamically booked via a cloud.

Determined evaluations of the determinations of the first routes 105 may be collected and rendered in an appropriate manner. For example, the specific ratios may be offset with respect to one another to produce a higher-level characteristic number. If the same exceeds a predetermined threshold value, insufficient quality of route determination may be determined. In another embodiment, the ratios are visualized, for example, in the manner of a histogram. Results may be output on an output device 320.

Not shown in FIG. 3 is an optional interaction device for selecting second routes 115 from the data storage 310.

### REFERENCE NUMERALS

100 System
105 First route
110 First point
115 Second route
120 Second point
125 First map
130 Second map
135 Starting point
140 Destination point
142 Off-road position
145 First section
150 Second section
155 Third section
160 First predetermined distance
165 Second predetermined distance
200 Method
205 Determine second route
210 Determine first route
215 Determine deviating sections
220 Evaluate route determination
300 Device
305 Processing device
310 Data storage
315 Vehicle
320 Output device

What is claimed is:

1. A method for evaluating a route determination, the method comprising the steps of:
determining a first route on a first map on the basis of a second route on a second map;
determining sections of one of the routes, wherein a determined section is further apart than a first predetermined distance from a corresponding section of the respective other route throughout its course;
determining lengths of the sections;
determining a ratio of a sum of the determined lengths to a length of the route.

2. The method according to claim 1, wherein the routes each represent roads having a predetermined minimum width and the first predetermined distance corresponds to at least twice the minimum width.

3. The method according to claim 1, wherein the lengths of the sections are each limited to a second predetermined distance before determining the sum.

4. The method according to claim 3, wherein determining the first route based on the second route is configured to be executed on board a vehicle, wherein a misdetermination of the first route may be detected during a travel of the vehicle across the predetermined second distance.

5. The method of claim 1, wherein there is a plurality of second routes; wherein meta-information is associated with the second routes; and wherein the second route is selected based on the meta-information.

6. The method according to claim 1, wherein a warning is issued if the determined ratio exceeds a predetermined threshold value.

7. The method according to claim 1, wherein ratios for a plurality of second routes are determined, and wherein further a portion of the ratios that is above a predetermined threshold value is determined.

8. A device for evaluating a route determination, wherein the device is configured to perform a method according to claim 1.

9. The device according to claim 8, further comprising a data storage for storing with a plurality of second routes.
